(19) United States
(12) Patent Application Publication
(10) Pub. No.: US 2008/0037939 A1
(43) Pub. Date: Feb. 14, 2008

(54) Splicing small core photonic crystal fibers and conventional single mode fiber

(75) Inventors: Limin Xiao, Hong Kong (CN); M. Suleyman Demokan, Hong Kong (CN); Wei Jin, Hong Kong (CN)

Correspondence Address: ATTN: Maquita Wong;The Hong Kong Polytechnic University, 1800 Diagonal Road, Suite 600, Mailbox #119, Alexandria, VA, 22314, US

(73) Assignee: The Hong Kong Polytechnic University, Kowloon (HK)

(21) Appl. No.: 11/878,176

(22) Filed: Jul. 23, 2007

Related U.S. Application Data
(60) Provisional application No. 60/834,175, filed on Jul. 31, 2006.

(51) Int. Cl. G02B 6/255

(52) U.S. Cl. 385/96

(57) ABSTRACT

The present invention relates to a method for splicing a conventional single mode fiber and a photonic crystal fiber having a small core. The method, relying upon an offset fusion splicer, applies repeated arc discharges having weak current and short duration. The method results in a low loss between 1.5 dB to less than 0.5 dB.

### BACKGROUND

Photonic crystal fibers (PCFs), which are also named microstructured optical fibers or holey fibers, have been investigated with great interest since the mid 1990's. PCFs have a periodic array of micro-holes that run along the entire fiber length. They typically have two kinds of cross sections: one is an air-silica cladding surrounding a solid silica core; the other is an air-silica cladding surrounding a hollow core. The light guiding mechanism of the former is provided by means of modified total internal reflection (index-guiding); the light guiding mechanism of the latter is based on photonic band gap effect (PBG-guiding). Because of their freedom in design and novel wave-guiding properties, PCFs have been used for a number of novel fiber optic devices and fiber sensing applications that are difficult to be realized by use of conventional fibers.

For index-guiding PCFs, many novel fibers have been developed, such as endlessly single mode PCFs, large mode area PCFs, and nonlinear PCFs. Because of the requirement of design, some index-guiding PCFs have a smaller core than the conventional single mode fibers (SMF). Nonlinear PCFs typically have a core diameter of less than 4 μm can be used for super-continuum generation, optical coherence tomography, Raman amplification, optical parametric amplification, wavelength conversion, and so on.

Connection conventional fibers using a commercial fusion splicer is a mature technology. However, low loss connection between PCFs and single mode fibers (SMFs) using a fusion splicer is still a challenge due to two main reasons: one is that the mode mismatch between a SMF and a PCF causes the coupling loss; the other is that the air holes of PCFs in the joint part is easy to collapse completely in practical operations, which increases the fiber loss due to destroying the light guiding structure in the joint part.

To realize the full potential of PCFs, a number of methods for connecting PCFs and SMFs are proposed. These methods include free space coupling, fusion splicing, CO₂ laser splicing, tapering and integrating a SMF with a PCF during the manufacturing stage of the PCF.

Free space coupling generally requires the use and alignment of lenses to achieve good coupling efficiency, however, the lens system makes the fiber connection bulky and impractical although it can be used in coupling between a small-core PCF and a SMF. Another modified lens couplling method was described by Yablon and Bise in “Low-loss high-strength microstructured fiber fusion splices using grin fiber lenses,” IEEE Photonic Technology Letters, Vol. 17, No. 1 (2005). In this method, three splices and controlled lengths of fiber lens and a section of coreless fiber are required, which makes the method complicated in practical operation. And this approach is suitable only for PCFs that have mode field diameters larger than 3.5 μm, thus this approach is not suitable for PCFs having small-core.

CO₂ laser splicing between PCFs and SMFs was introduced by Chong and Rao in “Development of a system for laser splicing photonic crystal fiber,” Optics Express, Vol. 11, No. 12 (2003). This laser fusion method is to achieve minimum collapse of air holes, thus this method is only suitable for PCFs that have similar mode field diameters with SMFs, not suitable for small-core PCFs.

Tapering coupling has been used to provide low loss coupling between SMFs and PCFs (see e.g. WO0049435, US2002/0114574A1 and US2004/0096174A1). However, tapering is a time-consuming process which needs laborious work in manufacturing of tapered fiber regions although it can be used to coupling between small-core PCFs and SMFs.

Integrating a SMF with a PCF during the manufacturing stage of the PCF was described by Leon-Saval et al. in “Splice-free interfacing of photonic crystal fibers,” Optics Letter, Vol. 10, No. 13(2005). This method can avoid connection loss between SMFs and small-core PCFs. However, this method requires fabrication of a special PCF preform which is very expensive.

Fusion splicing SMFs and PCFs with similar mode field diameters has been achieved by use of a fusion splicer and by choosing a weak arc discharge current and a short fusion duration as described in US2003/0081915A1 and US2006/0051034A1 to avoid the collapse of the holes. In US2003/0081915A1, the end of the PCF offsets from the center of the arc produced by the splicer, which further reduces the possibility of hole collapsing of the PCF. In US2006/0051034A1, are discharges after a main discharge is used to increase connection strength. However, the aims of these two patents was to connect PCF and SMF with a similar mode size and minimize the change of hole size in the cladding to reduce the connection loss due to hole collapse. Hence, these methods cannot achieve low loss connection between SMFs and small-core PCFs because mode mismatch between them cannot be improved without modification of the air-hole sizes. So these methods are not suitable for splicing SMFs with small-core PCFs.

To realize easy and low-loss splicing between SMF and small core PCFs, novel designs of PCFs have been developed. For example, the material refractive index of the core is made higher than that of the cladding (Japanese No. 2002-243972 and US2006/0067632A1). By doing so, when the cladding air holes are completely collapse, the wave-guiding structure can still be kept even when the cladding air holes are completely collapsed. The collapsing of the air holes increases the effective index of the cladding and enlarges the mode field area and hence reduces the coupling loss. Another design in US2006/0067632A1 is a PCF that has an inner cladding with smaller holes and an outer cladding with bigger holes.

If the diameter of the air holes of a small-core PCF is reduced, the effective index of the cladding will increase because of the reduced air hole fraction in the cladding region. This will enlarge the mode field area of the PCF and make it possible to match the mode field area of the SMF And hence reduce the splicing loss between them. A numerical study has been carried out by Lmgsgaard and Bjarklev in “Reduction of coupling loss to photonic crystal fibers by controlled hole collapse: a numerical study,” Optics Communications, Vol. 237, Issues 4-6 (2004). However, a good control of the rate of air hole collapse and the final air hole diameter is a challenge in practical operation, especially with the use of a fusion splicer.

Fusion splicing a standard SMF and a small-core erbium-doped fiber with low loss was described in UK Paten GF 2256723A. An optimum mode field match based on the diffusion of core dopant by repeated arc discharges was achieved. However, this method is only suitable for fusion splicing between SMFs and erbium-doped fibers. Thereafter we will demonstrate a low loss fusion splicing method for SMFs and small core PCFs based on the gradual collapse of air-hole in PCFs by repeated arc discharges.

Fusion splicing is the most mature technology in splicing fibers and it has the advantages of simplicity, easiness and inexpensiveness. A splicing method based on the use of a conventional fusion splicer will allow the realization of low-cost connection of small-core PCFs and SMFs without the need of designing special PCFs, complicated heating and manufacturing platforms.

It is one object of the present system to teach a method of splicing a photonic crystal fiber having a small core with a conventional single mode fiber.

### DESCRIPTION

The present system proposes to provide a method for achieving low loss connection between a PCF having a small-core and a SMF by using a connectional fusion splicer.

The present invention further proposes aligning the PCF having a small-core (i.e., small-core PCF) and the SMF, applying an arc discharge, and then applying repeated arc discharges over the connection joint.

The present invention also proposes to avoid a substantial collapse of the air-holes at the end face of the PCF using a single arc discharge with a weak current and a short duration.

These and other features, aspects, and advantages of the apparatus and methods of the present invention will become better understood from the following description, appended claims, and accompanying drawings where:

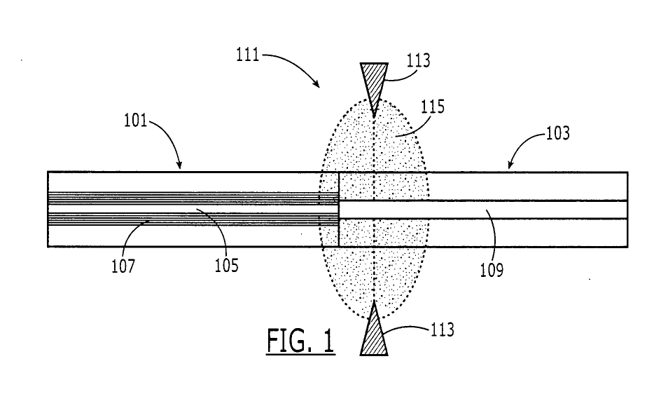

FIG. 1 shows the fusion splicing process;

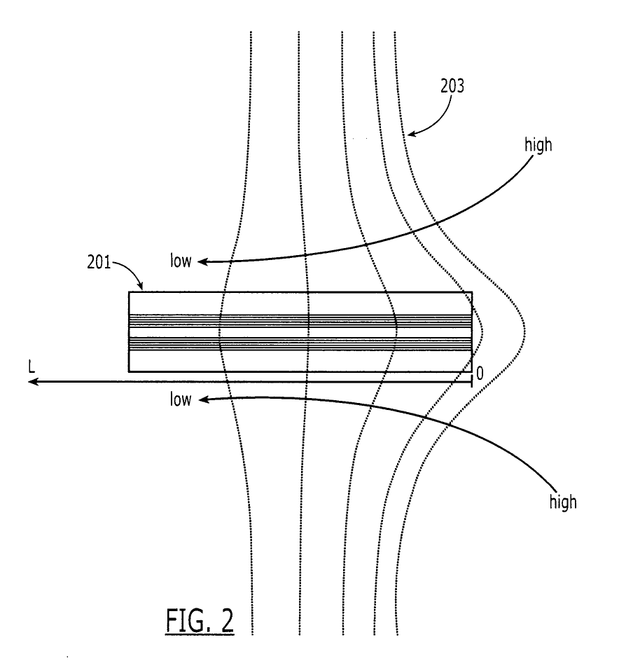

FIG. 2 shows a temperature distribution along the longitude direction of the photonic crystal fiber (PCF);

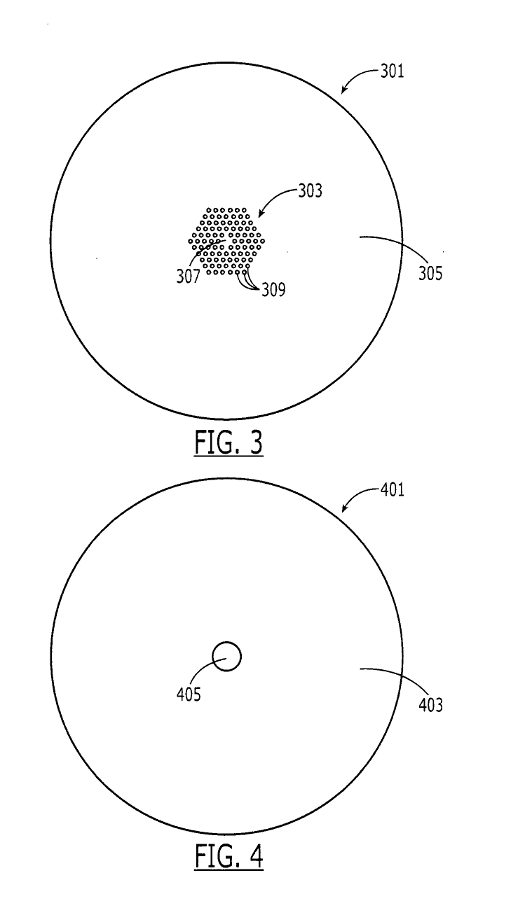

FIG. 3 shows a cross-section view of a photonic crystal fiber having a small-core;

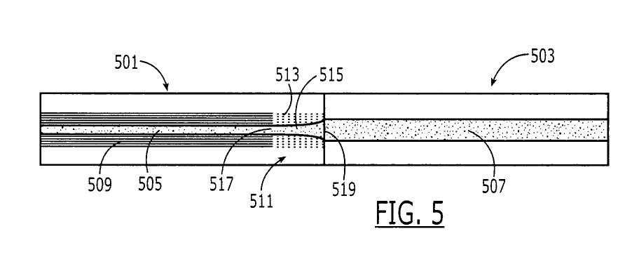

FIG. 4 shows a cross-section view of a single mode fiber (SMF);

FIG. 5 shows a side view illustrating an adiabatic mode field change between a PCF having a small-core and a SMF after repeated arc discharges;

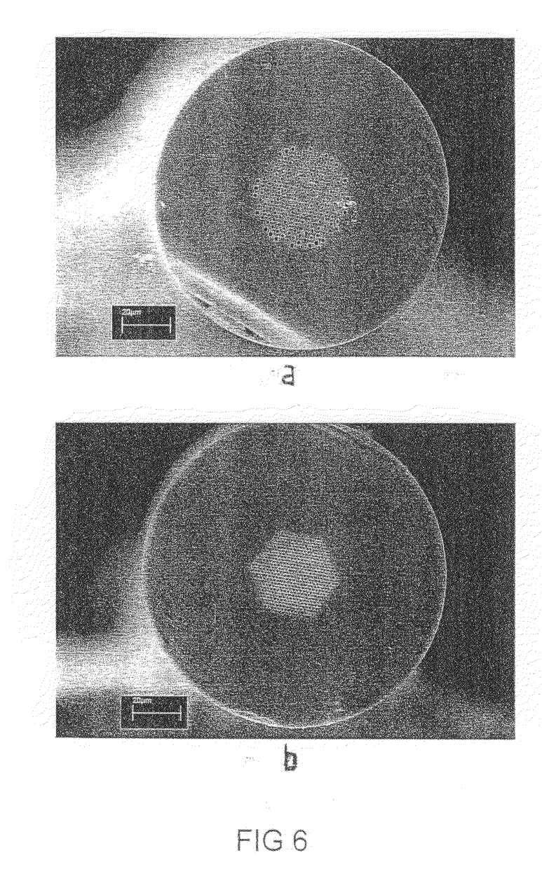

FIG. 6(a) is a scanning electron microscope image of a PCF LMA-5;

FIG. 6(b) is a scanning electron microscope image of a nonlinear PCF NL-1550-POS-1;

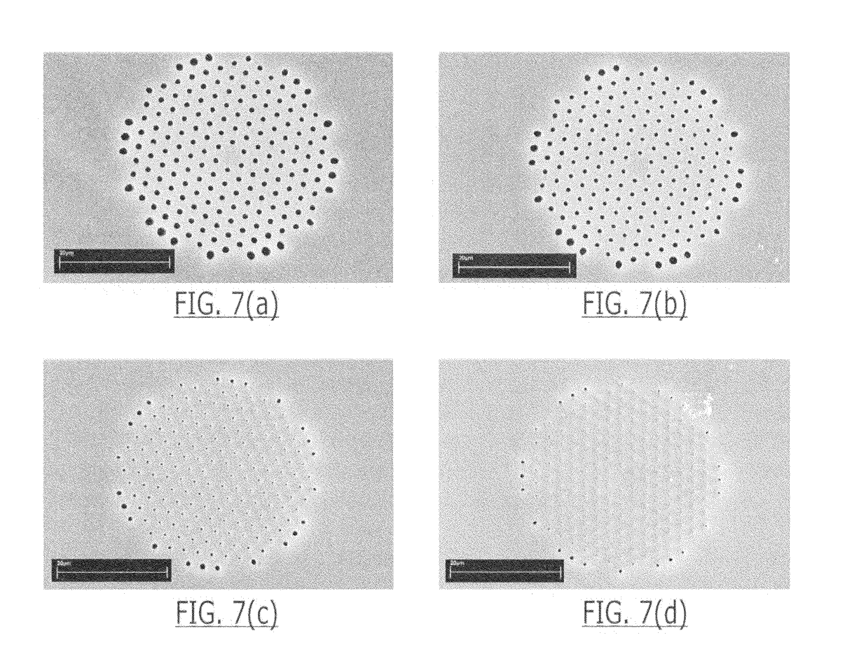

FIG. 7(a)-(d) shows the end-face images of the fiber LMA-5 after 2, 5, 7, and 9 time arc discharges;

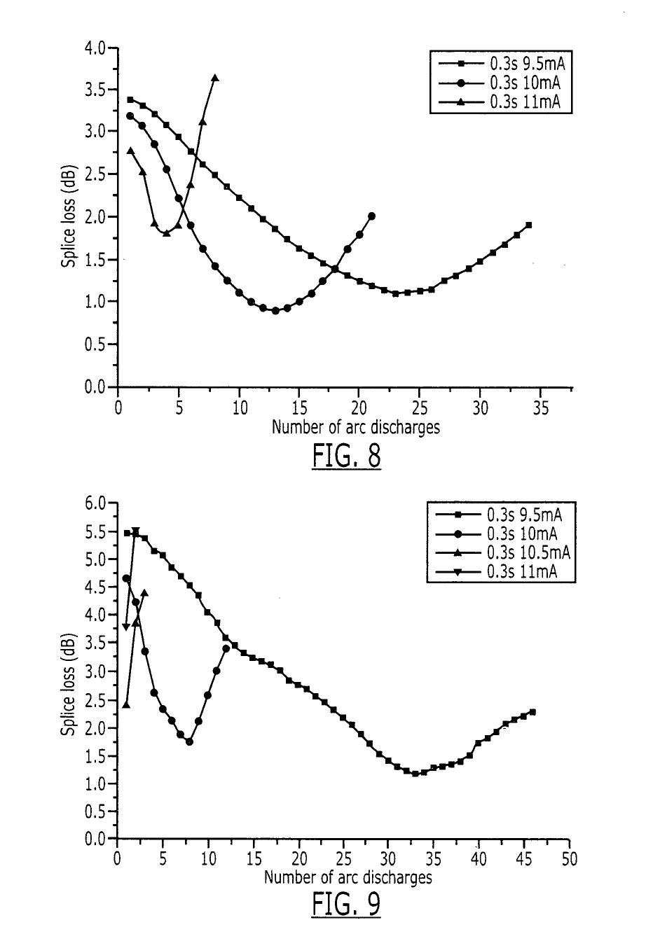

FIG. 8 shows the splicing loss between a SMF and a PCF LMA-5;

FIG. 9 shows the splicing loss between a SMF and a PCF NL-1550-POS-1.

As stated, the present invention teaches a method for achieving a low loss connection between a small-core PCF and a SMF using a conventional fusion splicer. Splicing occurs by applying a first arc discharge, followed by repeated arc discharge. The repeated arc discharge current is between 8 mA and 14 mA, with a duration 0.2 s and 0.5 s. The splicing loss between the small-core PCF and SMF is less than 2.0 dB, preferably less than 1.5 dB, more preferably less than 1.0 dB.

The following description of certain exemplary embodiment(s) is merely exemplary in nature and is in no way intended to limit the invention, its application, or uses. Throughout this specification the phrase “conventional single mode fiber” shall refer to a single mode fiber well known to be used in the art.

Now, to FIGS. 1-9,

FIG. 1 is an embodiment of the process of splicing a small-core PCF and a SMF. The PCF 101 has a solid small core 105 and an air-silicon cladding 107. The small core 105 is generally less than 4.5 μm in diameter, preferably less than 3.0 μm. The conventional SMF 103 has a larger core 109, generally 2 times or more larger than the PCF's core.

A fusion splicer 111 can be any conventional fusion splicer used in the art, such fusion splicers as disclosed in U.S. Pat. Nos. 4,288,143, 4,350,867, 5,016,971, 4,971,418, and 5,649,040. The fusion splicer 111 has two electrodes 113. In use, the PCF 101 and the SMF 103 are aligned so that the end parts of the two fibers abut in the arc discharge area 115 generated by the electrodes 113. However, the electrodes 113 are not positioned directly over the abutment, but rather offset therefrom. The electrodes 113 can be between 10 μm and 50 μm from the abutment interface. The offset, defined as the distance between the tip of the photonic crystal fiber and the electrode axis, avoids the total collapse of the cladding holes and thus controls the collapse of the air holes. Repeated weak arc discharges with a short duration are delivered from the electrodes 113. Repeated arc discharge current is between 8 mA and 14 mA, with repeated duration between 0.2 seconds and 0.5 seconds.

FIG. 2 shows the temperature distribution field 203 along the longitudinal direction of the PCF 201 during splicing. The temperature distribution field 203 of the PCF 201 decreases gradually along the longitudinal direction away from the splicing joint, which will cause an adiabatic air hole collapse along the longitudinal direction of the PCF.

After using an arc discharge to connect the PCF and the SMF, repeated arc discharges are applied over the joint to gradually collapse the air holes of the PCF to achieve an optimum hole diameter and an adiabatic mode field change in the longitudinal direction of the PCF to decrease the coupling loss.

FIG. 3 illustrates a cross-section view of a PCF, used in the present invention, the PCF 301 has a small solid silica core 307, an air-silica cladding 303, and a solid silica ring cladding 305. The core 307 and the cladding 303 have the same silica material. The air-silica cladding 303 has several air holes 309. The holes 309 are parallel to the longitudinal direction of the fiber 301. The mode field diameter of the fiber is determined by the diameter of the core, the diameter of the air hole, and the pitch of the 10 holes. Thereafter, PCFs will be used to splice with conventional SMFs.

FIG. 4 shows a SMF of the present invention, wherein the SMF 401 has a core 405 surrounding by a cladding 403. The core 405 has a higher refractive index than the cladding 403 because the core 405 has a higher concentration of the dopant atoms, such as germanium. The SMF 401 has a larger mode field diameter than the PCF. Thereafter, a SMF will be used to splice with a PCF having a small core.

FIG. 5 shows the mode field diameter change between a small-core PCF and a SMF 503 following repeated arc discharges. The optimal adiabatic mode field enlargement part 511 of the PCF is caused by collapsing the holes 513 gradually along the longitudinal direction. The enlargement part 511 has an adiabatic mode field 515 which matches the mode field 505 at the interface 517 and matches the field 507 at the interface 519.

Previously, the key challenge is the control of the rate of air hole collapse of the PCF to achieve the final optimum air hole diameter in practical operation by a fusion splicer. Through the present invention, an optimum adiabatic air hole collapse is achieved by repeat arc discharges.

### EXAMPLES

FIG. 6(a) shows a scanning electron microscope image of a small-core PCF LMA-5. The LMA-5 has a core diameter of 4.5 μm, a pitch λ=2.9 μm and a relative hole size d/λ=0.44. The mode field diameter and numerical aperture of the LMA-5 are respectively 4.1 μm and 0.23 at 1550 nm. FIG. 6(b) shows a scanning electron microscope image of another small-core PCF: NL-1550-POS-1. The NL-1550-POS-1 has an average core diameter of about 2.1 μm. The mode field diameter and numerical aperture of the NL-1550-POS-1 are respectively 2.8 μm and 0.4 at 1550 nm.

The SMF used in our experiment is SMF-28 from Corning that has a core diameter of 8.3 μm, the mode field diameter and numerical aperture at 1550 nm are about 10.4 μm and 0.14, respectively. The butt coupling loss a between a PCF and a SMF, for optimal alignment, may be estimated by

$$α = - 20 log ( \frac{2 {ω}_{PCF} {ω}_{SMF}}{{ω}_{PCF}^{2} + {ω}_{SMF}^{2}} ) \qquad ( 1 )$$

where 2ω_{PCF} and 2ω_{SMF} are respectively the mode field diameters of the PCF and the SMF. The butt coupling loss for light propagating from SMF-28 to LMA-5 and to NL-1550-POS-1 fibers were experimentally measured at 1550 nm and found to be 3.62 dB and 6.30 dB, respectively, which agree well with the theoretical estimation given by Eq. (1), i.e., 3.32 dB and 5.98 dB.

If the small-core PCF and the SMF are directly spliced together with a single weak arc discharge current and short arc duration, they splicing loss was found to be larger and is slightly smaller than the butt coupling loss. This is expected because the hole collapse under very weak discharge is negligible and the splicing loss is due to the mode field mismatch. If the small-core PCF and the SMF is spliced by use of the discharge parameters in the splicing program used for standard SMFs, the splicing loss would be very larger, e.g. above 10 dB, because the overheat collapses the air holes completely, destroying the light guiding structure in the joint part.

### Example 1

### LMA-5/SMF-28 Splicing

The output power from the pigtail fiber (SMF-28) of a 1550 nm source was measured first, and the LMA-5 with one end connected to a power meter was then aligned optimally with the SMF-28 fiber and the power coupled to the LMA-5 was detected. The coupling loss, which is the difference between the two measurements, was found to be 3.62 dB. An Ericsson FSU-975 fusion splicer was then used to fusion splice the LMA-5 with the SMF-28.

The typical parameters-set of FSU-975 for splicing two SMFs are: gap 50 μm, overlap 10 μm, prefusion time 0.2 s, prefusion current 10.0 mA; fusion time one 0.3 s, fusion current one 10.5 mA; fusion time two 2.0 s, fusion current two 16.3 mA; fusion time three 2.0 s, fusion current three 12.5 mA; the center position is 255. During prefusion the fiber ends are cleared by low level heating, and the major, fusion process is fusion time two. Hence we set the fusion time one and three to zero. We set fusion time two to 0.3 s and varied fusion current two to perform discharge tests. The prefusion current was set to 5.0 mA instead of 10 mA to avoid heat collapse of the holes at the PCF end face. We set the center position to 205 which means the offset distance is 50 μm, and set the overlap to 1 μm (instead of 101m) to avoid destroying the structure of the PCF; we then varied fusion current two from 9.5 mA to 11 mA.

FIG. 7(a)-7(d) shows the end-face image of the fiber LMA-5 taken by a scanning electron microscope after 2, 5, 7, and 9 time arc discharges. The fusion current and duration was 10.0 mA and 0.3 seconds. By withdrawing the SMF just before the start of the arc discharge, the end face of the LMA-5 fiber will not be spliced to the SMF-28 and it will only be heated by a weak arc discharge that will cause the air holes collapse to some degree, then we continue to apply the same arc discharges to heat the LMA-5. As shown in FIG. 7(a), the average hole diameter is 0.83 μm when the number of arc discharge is 2. The hole shrinks from 0.83 μm to 0.70 μm when the number of discharges is 5 (FIG. 7(b)). The hole then reduces to 0.24 μm for 7 discharge (FIG. 7(c)). When the arc discharge occurs 9 times, almost all holes are closed (FIG. 7(d)). The collapse of holes is usually faster than when the LMA-5 and SMF are fused together because, when they are not fused together, more heat will apply to the end of the LMA-5 due the to exposure of the end face. The collapse of the holes is expected to be slower when splicing LMA-5 with SMF-28 fiber for the same number of arc discharges.

Splicing between the LMA-5 and SMF-28 fibers is then performed. When the fusion time was fixed to 0.3 s and the number of arc discharges is 1, the splicing losses are 3.38 dB, 3.19 dB, and 2.77 dB for fusion currents of 9.5 mA, 10 mA, and 11 mA. These losses are less than theoretical valve (3.32 dB) because the holes are slightly collapsed during fusion splicing, and mode field areas are slightly enlarged. However, a single discharge cannot optimize hole-collapse and hence minimize splicing loss.

Repeated arc discharges to collapse air holes gradually to achieve low loss splicing was performed. For a fixed fusion time of 0.3 seconds, a minimum splice loss of 1.1 dB was achieved for a fusion current of 9.5 mA after 23 times of repeated arc discharges; when the fusion current was increased to 10.0 mA, the minimum splicing loss is 0.9 dB when arc discharges 13 times; when the fusion current increased to 11 mA, the minimum splicing loss is 1.8 dB when arc discharges 4 times, as shown in FIG. 8. The minimum splicing loss is achieved by optimal gradual mode area expansion, which is the best matching of the mode field at the interface, as shown in FIG. 5.

### Example 2

### NL-1550-POS-1/SMF Splicing

The same method was used to splice the fiber NL-1550-POS-1 and the fiber SMF-28. When the fusion time is 0.3 s and fusion current is 9.5 mA, the minimum splicing loss is 1.2 dB when arc discharges 33 times, as shown in FIG. 9; when the fusion current increased to 10.0 mA, the minimum splicing loss is 1.75 dB when arc discharges 8 times; when the fusion current increases to 10.5 mA and 11 mA, the minimum splicing losses are 2.41 dB and 3.8 dB respectively when arc discharges only once, further discharge will increase the splicing loss.

The optimal gradual mode area expansion and minimum splicing loss has been shown to occur through optimal combination of discharge current, discharge duration, and number of repeated discharges, preferably 9-12 mA, 0.25-0.35 s, and 10-33 discharger, respectively.

Having described embodiments of the present system with reference to the accompanying drawings, it is to be understood that the present system is not limited to the precise embodiments, and that various changes and modifications may be effected therein by one having ordinary skill in the art without departing from the scope or spirit as defined in the appended claims.

In interpreting the appended claims, it should be understood that:

a) the word “comprising” does not exclude the presence of other elements or acts than those listed in the given claim;

b) the word “a” or “an” preceding an element does not exclude the presence of a plurality of such elements;

c) any reference signs in the claims do not limit their scope;

d) any of the disclosed devices or portions thereof may be combined together or separated into further portions unless specifically stated otherwise; and

e) no specific sequence of acts or steps is intended to be required unless specifically indicated.

1. A method of splicing a conventional single mode fiber (SMF) and a small-core photonic crystal fiber (PCF), comprising the steps of
positioning electrodes of a fusion splicer offset from the abutment interface of said conventional SMF and said small-core PCF;
applying a first arc discharge; and
applying repeated arc discharge current between 8 mA and 14 mA for a duration between 0.2 seconds and 0.5 seconds;
wherein said small-core PCF has a core diameter less than 4 μm.

2. The method of splicing said conventional SMF and said small core PCF in claim 1, wherein said electrodes are positioned from 10 μm to 50 μm from said abutment interface.

3. The method of splicing said conventional SMF and said small core PCF in claim 2, wherein said conventional SMF has a core diameter 2 times or more larger than said PCF core diameter.

4. The method of splicing said conventional SMF and said small-core PCF in claim 1, wherein said method results in a splicing loss of between 1.5 dB to smaller than 0.5 dB.

5. The method of splicing said conventional SMF and said small-core PCF in claim 1, wherein the number of repeated arc discharges are larger than 3 and less than 50.

6. The method of splicing said conventional SMF and said small core PCF in claim 1, wherein there exist an optimal combination of discharge current, discharge duration, and number of repeated discharges to achieve optimal gradual mode area expansion and hence to achieve the splicing loss of between 1.5 dB to smaller than 0.5 dB.

7. The method of splicing said conventional SMF and said small core PCF in claim 1, wherein the degree of average hole collapse near the splicing joint is larger than 50%.

8. The method of splicing said conventional SMF and said small core PCF in claim 1, wherein repeated arc discharges are applied automatically.
